(19) United States
(12) Patent Application Publication
(10) Pub. No.: US 2015/0175361 A1
(43) Pub. Date: Jun. 25, 2015

(54) PROFILED CONVEYOR ROLL

(71) Applicant: INTERROLL HOLDING AG, Sant'Antonino (CH)

(72) Inventor: Peter Uttrup, Muttenz (CH)

(21) Appl. No.: 14/414,097

(22) PCT Filed: May 8, 2013
(86) PCT No.: PCT/EP2013/001381

§ 371 Date: Jan. 10, 2015

(30) Foreign Application Priority Data
Jul. 17, 2012 (EP) 12380036.9

(51) Int. Cl. B65G 23/04; B65G 15/28

(52) U.S. Cl. CPC B65G 23/04; B65G 15/28

(57) ABSTRACT

A drive roller for a conveyor belt with a profile shell (10), in which teeth (12) and engagement portions (14) are formed along the axial direction of the drive roller (1) such that it holds:

$$\frac{{D}_{A} \cdot π}{{N}_{Z}} = 52.0 mm \pm 2 mm$$

where DA denotes the external diameter of the drive roller (1) with teeth (12) and NZ denotes the number of teeth (12) of the profile shell (10).

The invention relates to a drive roller for a conveyor belt and to a conveyor band having a drive roller.

Drive rollers are used in conveyor belt systems to drive a belt or conveyor belt on which items are transported. To this end, the drive roller transmits its torque to the conveyor belt that passes over the drive roller, said conveyor belt being frictionally tensioned or stretched over the drive roller.

Moreover, conveyor belts with a specially designed profile on the inside for positive power transmission are known as another drive system for a conveyor belt. The conveyor belts have inward-facing engagement elements, such as nubs and/or ribs, which are driven by special gears. Here, a thus-profiled conveyor belt passes around a plurality of gears that are arranged parallel to each other in the axial direction. The gears have engagement portions that are matched to the special profile of the engagement elements of the conveyor belt.

It is the object of the invention to provide a universally usable drive device for conveyor belts.

This object is solved by the subject matters of the independent claims.

One aspect of the invention relates to a drive roller for a conveyor belt with a profile shell, in which teeth and engagement portions are formed along the axial direction of the drive roller such that it holds:

$$\frac{{D}_{A} \cdot π}{{N}_{Z}} = 52.0 mm \pm 2 mm$$

D_{A} denotes the external diameter of the drive roller with teeth and N_{Z} denotes the number of teeth of the profile shell.

Such a drive roller differs from a gear in that, inter alia, the drive roller is substantially cylindrical in shape, wherein the drive roller is formed to be longer in the axial direction of the cylinder than in the radial direction or in the direction of the cylinder diameter. In particular, a drive roller may be formed to be at least twice or three times as long in the axial direction as it is wide in the radial direction. The drive roller extends in the axial direction.

A drive roller is formed as a driven roller. The drive roller may comprise a drive, e.g. a drum motor. The drive can drive the drive roller such that the circumferential surface of the drive roller rotates about its longitudinal axis. For transmitting the torque of the drive roller to a conveyor belt that passes around the drive roller at least partially, the drive roller has a profile shell. The profile shell is formed in the region of and along the cylindrical surface of the cylindrical drive roller. The profile shell has teeth and engagement portions, which extend in the axial direction of the drive roller and are adapted to transfer the power of the torque of the drive roller for driving a conveyor belt. The teeth and the engagement portions are formed in parallel to the axial direction of the drive roller.

The profile shell may be formed either integrally as part of the drive roller, wherein the drive roller has a profiled cylindrical drum, or may be formed as a separate component arranged in the cylinder surface area of the drive roller.

Conveyor belts are designed to pass around a plurality of rollers in an endless loop. The inside of such a conveyor belt faces toward the rollers, the outside of the conveyor belt is provided for transporting items.

If a profiled conveyor belt is applied around a drive roller according to the invention, engagement elements of the profiled conveyor belt can engage with the engagement portions of the drive roller. When the drive roller is being driven, the teeth of the drive roller transfer its torque to the profiling of the conveyor belt and thus to the conveyor belt itself.

A type of conveyor belt with profiling is the so-called thermoplastic, homogeneous belts (“thermoplastic homogeneous belts”). This type of belts or conveyor belts is—depending on the manufacturer—produced with the most varied profiles. These belts are manufactured e.g. with semi-circular nubs or rail-like projections, which are formed transverse to the direction of motion of the belt, as engagement elements. With respect to the different shape, the engagement elements of these conveyor belts are spaced differently from each other.

Therewith, usually a gear produced separately for this conveyor belt is to be used in order to drive the respective conveyor belt. A large part of the conveyor belts on the market has a clearance between the engagement elements in the direction of motion of the conveyor belt of about one or two inches. The clearance is not a measure of only of the space between the engagement elements, but is a measure of the width of the engagement-free space plus the width of an engagement element. In other words, the clearance is the distance in the direction of transport from the engagement element end to the adjacent engagement element end. The clearance thus denotes the pitch of the drive roller.

Thus, for example, Intralox manufactures thermoplastic homogeneous belts, which have a clearance (“pitch”) between the individual engagement elements of 1.96849 inches. Other belts manufactured by this company have a clearance of 1.02361 inch. “Pitch” or “clearance” refers to the regularity with which the engagement elements of the profiled conveyor belt are formed with respect to each other as seen in the direction of motion. The direction of motion of the conveyor belt is the direction in which the conveyor belt is adapted and provided to transport items.

While conveyor belts are manufactured in the metric measurement system (1.96849 inch correspond to approximately 50 mm) by European manufacturers, American manufacturers mostly manufacture conveyor belts with inch dimensions of exactly one or two inch(es).

The drive roller according to the invention can be used to drive a plurality of different conveyor belts, in particular for both inch pitches and metric pitches. The teeth of the profile shell of the drive roller are spaced apart by about two inches, and can thus drive both conveyor belts with a clearance of about two inches as well as conveyor belts with a clearance of about one inch. If a conveyor belt with a clearance of about one inch is used, the teeth of the profile shell can then engage only at every second engagement element of the conveyor belt to use the torque of the drive roller for driving the conveyor belt.

Such a two-inch spacing of the teeth of the profile shell in the circumferential direction of the shell of the drive roller can be indicated mathematically as follows:

$$\frac{{D}_{A} \cdot π}{{N}_{Z}} = 52.0 mm \pm 2 mm$$

The term D_{A} multiplied by the number 7 is a measure for the outer circumference of the drive roller. Here, D_{A} denotes the outer diameter of the roller including the tooth length of the individual teeth of the drive roller, also called tip diameter. This outer circumference of the drive roll divided by the number of teeth of the drive roller is made about two inches, i.e. 50.8 mm, large.

Thus, the driving roller has the advantage of being able to drive a majority of the conveyer belts available on the market. For example, if the conveyor belt is defect, it can be exchanged more easily, since it is not necessary to organize a very special type of conveyor belt of a particular manufacturer, but almost any profiled conveyor belt can be used.

Here, a pitch of approximately 51.5 mm for the drive roller is particularly preferred. This special pitch is formed to be a bit larger than the pitch of the conventional conveyor belts. Thereby, conversion of the torque of the drive roller for driving a conveyor belt is made possible on a guide tooth of the drive roller, and at the same time sufficient play for deformation is provided.

One embodiment relates to a drive roller in which the teeth and the engagement portions are formed substantially along the entire shell length of the drive roller. In this way, the transmission of the torque of the drive roller is independent of the exact position of the engagement elements of the conveyor belt in the transverse direction of the belt. For example, gears for driving conveyor belts with nubs need to be exactly aligned (in the axial direction) in order to surround the nubs of the belt for driving. The drive roller has teeth and engagement portions, which extend continuously over the length of the drive roller in the axial direction, i.e. substantially along the entire shell. Thus, the universal applicability of the drive roller is increased.

According to one embodiment, the teeth of the drive roller have tooth flanks, which are adapted to transmit torque of the drive roller to engagement elements arranged in the engagement portions. The surfaces of the tooth flanks may be in one plane. The engagement elements may be engagement elements of a conveyor belt. Thus, the torque of the drive roller is effectively driven for driving the conveyor belt in the direction of motion of the conveyor belt.

One embodiment relates to a drive roller in which the material of the profile shell has a low friction coefficient with respect to the material of the conveyor belt. In this case, the friction coefficient means the sliding friction coefficient μ. A low friction coefficient means that the coefficient of friction is less than 0.2. Most conveyor belts are made of PUR (polyurethane) or PE (polyester). For such conveyor belts, a profile shell of the drive roller made of PUR has a low friction coefficient, for example. The material of the profile shell is therefore matched to the material of the conveyor belt, so that the conveyor belt can be driven smoothly and supplely by the drive of the drive roller. The pitch of the drive pulley, i.e. the clearance between the tooth flanks of the profile shell, is designed for a plurality of conveyor belts. To this end, the pitch of the profile shell may be formed to be slightly larger than the pitch of the conveyor belt. Thereby, power is transmitted at only one tooth of the profile shell. If the driving gear separates from the conveyor belt at the end of its passing-around, the conveyor belt slides to the subsequent tooth up to the stop, which then is the next to convert the torque of the drive roller for driving the conveyer belt. A low friction coefficient makes this sliding movement of the conveyor belt to the subsequent tooth of the drive roller supple.

One embodiment relates to a drive roller in which the mean width of the teeth is formed to be narrower than the mean width of the engagement portions. Thus, the drive roller has enough free space between the individual teeth so as to accommodate both engagement elements of a conveyor belt with a pitch of two inches and engagement elements of a conveyor belt with a narrow one-inch pitch, which are arranged therebetween. In such narrow conveyor belts, every second engagement element points into the engagement portion of the drive roller without abutting against a tooth flank of one of the teeth of the profile shell of the drive roller. Such an “open” arrangement of the teeth of the drive roller has the further advantage that the profile shell, and thus the roller outside is particularly easy to clean, since the engagement portions formed as depressions are wide enough to be easily accessible to a cleaning device.

Here, the mean width of the teeth is between 3 mm and 7 mm, and the mean width of the engagement portions between 44 mm and 48 mm. The width of the teeth (in the circumferential direction of the shell) may decrease in the axial direction, the teeth taper outward. The engagement portions may be formed correspondingly in the opposite way so as to widen outward (in the radial direction). The mean width of the teeth thus describes the average width of the teeth, averaged from their beginning the bottom of the engagement portions to the radially outer tooth end. The mean width of the engagement portions is defined accordingly.

According to an alternative embodiment, the mean width of the teeth is formed to be wider than the mean width of the engagement portions. In this embodiment, the stability of the teeth is particularly high, and the teeth have a long service life.

Here, the mean width of the teeth may be 40 mm to 48 mm, and the mean width of the engagement portions may be 3 mm to 11 mm.

In one embodiment, tooth flanks of the teeth for transmitting torque of the drive roller are each inclined between 6° and 20°, preferably between 10° and 15° with respect to the radial direction, particularly preferably by 12°. Here, the surface of the tooth flanks can be formed so that it lies in one plane. The tooth flanks can extend continuously over the entire length of the drive roller in the axial direction. By this inclination of the tooth flanks with respect to the perpendicular in the radial direction to the drive roller, both conveyor belts with rounded nubs as engagement elements and conveyor belt provided with steep engagement element teeth can be driven effectively. Thus, such an inclination is particularly suitable for use with different types of conveyor belts.

According to one embodiment, the drive roller for a conveyor belt is formed with engagement elements, wherein the length of the teeth in the radial direction is matched to the size of the engagement elements of the conveyor belt. Preferably, the teeth of the profile shell are formed such that the teeth project beyond the bottom of the engagement portions in the radial direction by 0.5 cm-1.5 cm, particularly preferably 9.5±1 mm. Such a length of the teeth, and thus a corresponding depth of the engagement portions, is particularly well matched to the dimension of the previously known conveyor belts, so that the engagement elements of most profiled conveyor belts engage in the engagement portions of the drive roller, but do not reach the bottom of the engagement portions. The formation of the teeth and of the engagement portions such that the engagement portions are a little lower than most engagement elements are long, has the advantage of being able to operate the conveyor belts without buckling of the conveyor belt, in particular upon redirectioning around the drive roller.

In one embodiment, the profile shell is made of PUR. PUR stands for polyurethane, such as AXSON XP 3587/3. This material is very good to process, stable and easy to clean. Particularly for a conveyor system for the transport of foodstuffs, cleaning of the transport system is very important. A profile shell of PUR can be cleaned easily and thoroughly.

The drive roller may have a drum motor for rotating the drive roller about its longitudinal axis. Here, the profile shell and the drum motor may be frictionally and/or positively connected to one another. Thereby, efficient power transfer from the drum motor to the profile shell is provided.

In one embodiment, the drive roller is provided with an antibacterial additive. An antibacterial additive is recommended e.g. when the drive roller is used in a conveyor system for food products in order to increase the standard of hygiene. Such an antibacterial additive may e.g. be formed on the basis of silver ions uniformly integrated into the material of the drive roller. The advantage of an additive with respect to, for example, an anti-bacterial coating is the longer service life.

One aspect of the invention relates to a conveyor band with at least one of the drive rollers of the invention and a conveyor belt, wherein the drive roller is formed as an idler pulley for the conveyor belt. Idler pulley means that the conveyor belt is arranged around the drive roller so that its direction of motion changes by 180. The idler pulley is thus disposed at one end of the conveyor belt or of a portion of the conveyor belt.

According to one embodiment, the clearance of the drive roller is formed to be greater than the clearance of the conveyor belt. This allows power transmission at one drive roller tooth each. Preferably, the pitch of the drive roller is at least 0.5 mm greater than the pitch of the conveyor belt, particularly preferably at least 1.5 mm greater than the pitch of the conveyor belt, to compensate for elastic deformation of the conveyor belt. The pitch of the drive roller may be formed so that it is made not more than 4.0 mm greater than the pitch of the conveyor belt in order to avoid a conflict between the teeth of the drive roller and the engagement elements of the conveyor belt.

The invention will now be described by means of embodiments shown in the figures. Individual features shown in the figures of the embodiments may be combined with features of other embodiments. In the drawings:

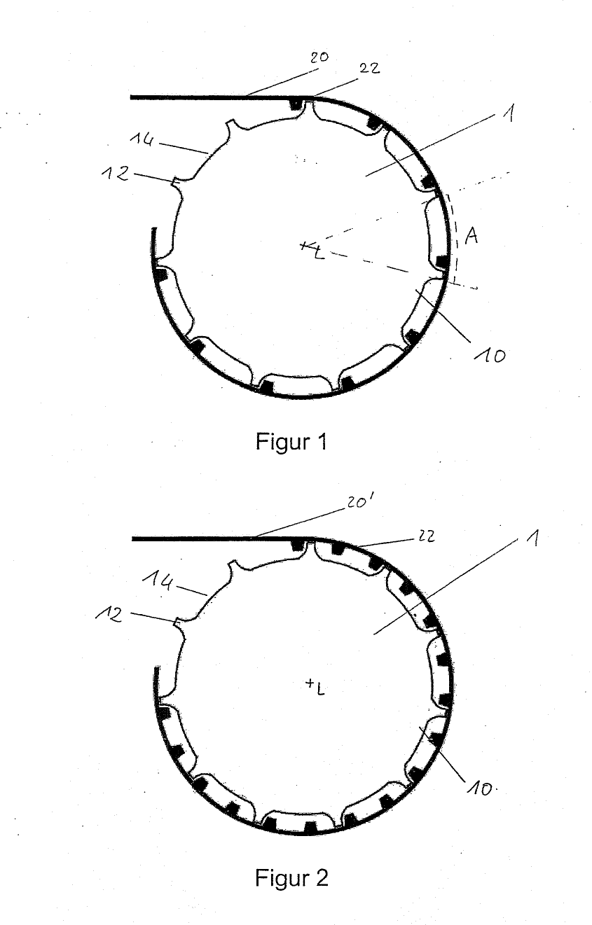

FIG. 1 is a schematic illustration of a cross section of a drive roller for driving a first conveyor belt;

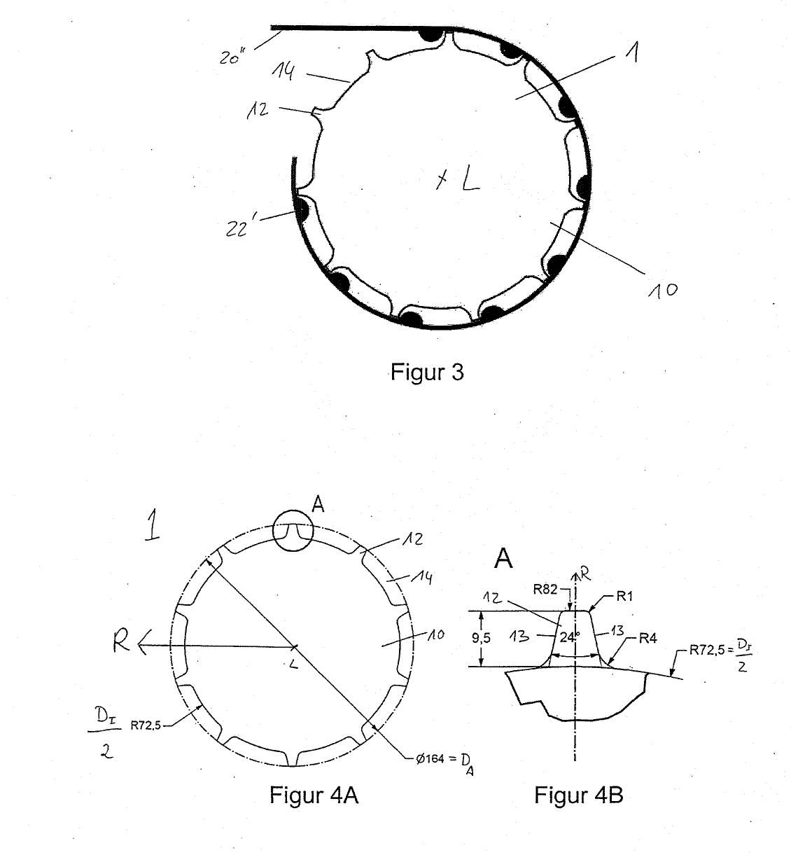

FIG. 2 is a schematic illustration of a cross section of a drive roller for driving a second conveyor belt;

FIG. 3 is a schematic illustration of a cross section of a drive roller for driving a third conveyor belt;

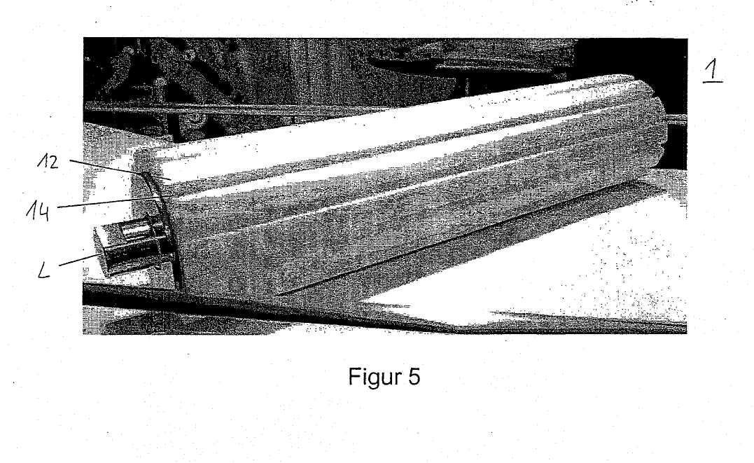

FIG. 4A is a cross section of a drive roller;

FIG. 4B is an enlarged view of FIG. 4A with a tooth of the drive roller; and

FIG. 5 is a photograph of a drive roller with wide teeth.

FIGS. 1 to 3 show, in a schematic illustration, a cross section of an embodiment of a drive roller 1. The drive roller 1 is substantially cylindrical and rotatable about its longitudinal axis L. The direction of extension of the longitudinal axis L defines an axial direction of the drive roller 1.

The drive roller 1 comprises a motor (not shown in FIGS. 1 to 3), which drives the drive roller 1 so that the drive roller 1 rotates about its longitudinal axis L. This torque can be used to drive a conveyor belt 20 (shown in FIG. 1), 20′ (shown in FIG. 2), 20″ (shown in FIG. 3).

To this end, the drive roller 1 comprises a profile shell 10 formed along the cylindrical surface of the drive roller 1. The profile shell 10 is coupled to the motor of the drive roller 1 so that power transmission from the motor to the profile shell 10 is possible: If the motor drives the drive roller 1, the drive roller will rotate with the profile shell 10 about its longitudinal axis L. The profile shell 10 may be formed e.g. from PUR (polyurethane). When using the drive roller 1 with a profile shell 10 of PUR for driving a conveyor belt 20, 20′, 20″, which may also be made of polyurethane, one obtains a sliding effect between the two PUR materials, which is advantageous to a smooth or jerk-free drive of the conveyor belt 20, 20′, 20″.

Therefore, the drive roller 1 is particularly suitable for driving a thermoplastic, homogeneous belt (“thermoplastic homogeneous belt”), which are usually made of PUR or PE.

The profile shell 10 has teeth 12 and engagement portions 14, which are formed on the circumferential surface of the drive roller 1 continuously in the axial direction of the drive roller 1. The teeth 12 and the engagement portions 14 are used for transmitting the torque of the drive roller 1 to the conveyor belt 20, 20′, 20″. To this end, the teeth 12 are formed at regular intervals A of about two inches with respect to each other. The distance A of about two inches is measured in terms of the outer circumference of the shell of the drive roller.

Thermoplastic homogeneous belts as conveyor belt 20, 20′, 20″ are made with inward-directed engagement elements 22, 22′. Here, inward means that the engagement elements 22, 22′ face toward the drive roller 1 when the conveyor belt 20, 20′, 20″ is to be driven by the drive roller 1 in a working position.

The shape of the engagement members 22, 22′ dependents on the manufacturer. Some conveyor belts 20″ have semi-spherical nubs as engagement elements 22′, as shown in FIG. 3. Other conveyor belts 20, 20′ have lamella-like engagement elements 22 that extend along the entire transverse direction of the conveyor belt 20, 20′ (see FIGS. 1 and 2). The transverse direction of the conveyor belt is aligned parallel to the axial direction of the drive roller 1.

Conveyor belts with nubs as engagement elements on their inner side are produced with different distances in the transverse direction between the nubs. For driving them, use has so far been made of gears that need to have distances from each other that are precisely matched to the nub positions, so that the nubs engage the gears.

The drive roller 1 has teeth 12 and engagement portions 14, which extend continuously across the entire circumferential surface of the drive roller 1. Therefore, for driving a conveyor belt, it is not essential at what position in the axial direction of the drive roller 1 or in the transverse direction of the conveyor belt the engagement elements are arranged in order to engage the engagement portions 14 of the drive roller 1.

The drive roller 1 can be used to drive the most varied conveyor belts. To this end, the teeth 12 of the drive roller 1 are spaced from each other by about two inches in the circumferential direction of the shell. The conveyor belt 20, as shown in FIG. 1, has a clearance (“pitch”) between its engagement elements 22 of two inches. Thus, the teeth 12 can attack at each of the engagement elements 22 and convert the torque of the drive roller for driving the conveyor belt 20.

The conveyor belt 20′ shown in FIG. 2 has a clearance of one inch between its engagement elements 22. Both the clearance of the engagement elements 22 and the distance A between the teeth 12 have the width of one engagement portion plus the width of one engagement element 22 or tooth 12. In FIG. 2, the teeth 12 of the drive roller 1 rest against every second engagement element 22 of the conveyor belt 20′. An engagement element 22 of the conveyor belt 20′ respectively arranged therebetween engages the engagement portion 14 of the drive roller 1, but does not rest against any gear and is therefore not driven by the drive roller 1.

Between the individual teeth 12 of the drive roller 1, the engagement portions 14 are formed to be so wide (in the circumferential direction of the shell) that the engagement elements 22 “therebetween” can easily engage the engagement portion as well. In the embodiment of FIG. 2, two engagement elements 22 of the conveyor belt 20′ engage every engagement portion 14. This large distance between the individual teeth 12 of the drive roller 1 improves the versatility of the drive roller 1: Both the conveyor belt 20 (shown in FIG. 1) and the conveyor belt 20′ (shown in FIG. 2) may be driven by the same drive roller 1. To this end, the teeth 12 are formed to be substantially narrower in the circumferential direction of the shell of the the drive roller 1 than the wide engagement portions 14.

The nub-like, semi-circular engagement elements 22′ of the conveyor belt 20″ (shown in FIG. 3) can be driven by the same drive roller 1. The wide configuration of the engagement portions 14 provides sufficient space both for engagement of the narrow engagement elements 22 (see FIGS. 1 and 2) and the wider engagement elements 22′ (see FIG. 3).

Since many thermoplastic homogeneous belts are produced as conveyor belts with a clearance (pitch) of either one or two inches, but with very differently shaped engagement elements, the drive roller 1 is suitable for driving most of these belts.

For example, the company Infralox produces corresponding belts with clearances of 1.96849 inches and 1.02361 inches. Companies such as Volta and MAFDEL produce belts with these clearances (“pitch”). Others, mostly American companies, produce corresponding belts a clearance (pitch) of exactly one or two inches.

The pitch of the drive roller 1 is formed to be about 1 mm to 2 mm larger than the pitch of the conveyor belts 20, 20′, 20″. Therefore, most of the power transmission from the drive roller 1 to the respective conveyor belt 20, 20′, 20″ takes place from a single tooth 12 of the drive roller 1 to a single engagement element 22, 22′ of the conveyor belt 20, 20′, 20″. If this main load tooth comes off the conveyor belt 20, 20′, 20″ due to the rotational movement of the drive roller 1, the conveyor belt 20, 20′, 20″ will slide over the tips of the teeth 12 until an engagement element 22, 22′ hits the following tooth 12 of the drive roller and this tooth temporarily becomes the new main load tooth of the power transmission.

FIG. 4A shows a cross section of an embodiment the drive roller 1. A drum motor (not shown), which is approximately square in cross section, is arranged about the longitudinal axis L of the drive roller 1. The profile shell 10, which is positively connected to the drum motor, is arranged around the drum motor.

In the embodiment of FIG. 4A, the outer diameter D_{A} of the drive roller 1 is 164 mm, wherein this outer diameter includes the length of the teeth 12. The inner diameter d₁ is a measure of the diameter of the drive roller 1 to the bottom of the engagement portions 14 and is 145 mm. The tooth length is thus 9.5 mm. The embodiment shown in FIG. 4A comprises ten teeth 12 and ten engagement portions 14.

Thus, the distance A results from the outer diameter D_{A} times π divided by the number of teeth N_{Z}:

$$\frac{{D}_{A} \cdot π}{{N}_{Z}} = \frac{164 mm \cdot π}{10} \approx 51.52 mm$$

Other embodiments relate to e.g. drive rollers having an outer diameter D_{A} of 114.8 mm, 147.6 mm, 164 mm, and 196.8 mm with 7, 9, 10 or 12 teeth, respectively. Thus, all of these embodiments have a distance A of about 51.52±1.5 mm.

FIG. 4B shows a tooth 12 in an enlarged view of FIG. 4A. The tooth 12 projects out of the engagement portions 14 by 9.5 mm, or the engagement portions 14 are formed 9.5 mm deep in the profile shell 10. Tooth flanks 13 of the tooth 12 are inclined by 12° with respect to the radial direction R. With this angularly inclined configuration, the tooth flanks 13 are particularly well suitable for taking advantage of the plurality of differently shaped engagement elements of the conveyor belts for power transmission. Due to this inclination of the tooth flanks 13, the teeth are narrower 12 outward in the radial direction R.

FIG. 5 shows a photograph of an embodiment of a drive roller 1, in which the teeth are wider than the engagement portions. The distance A between the teeth is approximately two inches in this embodiment as well. The engagement portions 14 of the drive roller 1 shown in FIG. 5 are wide enough to drive both the conveyor belt 20 schematically shown in FIG. 1 and the conveyor belt 20″ shown in FIG. 3 with nubs as engagement elements 22.

### LIST OF REFERENCE NUMERALS

1 drive roller

10 profile shell

12 tooth

14 engagement portion

20 conveyor belt

20′ conveyor belt

20″ conveyor belt

22 engagement element

22′ engagement element

A distance

D_{A} outer diameter

D_{I} inner diameter

L longitudinal axis

N_{Z} number of teeth

R radial direction

What is claimed is:

1. A drive roller for a conveyor belt with a profile shell, in which teeth and engagement portions are formed along an axial direction of the drive roller such that the following relationship holds:
$$\frac{{D}_{A} \cdot π}{{N}_{z}} = 52.0 mm \pm 2 mm$$
where D_{A} denotes an external diameter of the drive roller with teeth and N_{Z} denotes the number of teeth of the profile shell.

2. The drive roller according to claim 1, wherein the teeth and the engagement portions are formed substantially along an entire shell length of the drive roller.

3. The drive roller according to claim 1, wherein the teeth have tooth flanks, which are adapted to transmit power from a torque of the drive roller to engagement elements arranged in the engagement portions.

4. The drive roller according to claim 1, wherein the material of the profile shell has a low friction coefficient with respect to the material of the conveyor belt.

5. The drive roller according to claim 1, wherein a mean width of the teeth is formed to be narrower than mean width of the engagement portions.

6. The drive roller according to claim 5, wherein the mean width of the teeth is between 3 mm and 7 mm, and the mean width of the engagement portions is between 44 mm and 48 mm.

7. The drive roller according to claim 1, wherein tooth flanks of the teeth for transmitting torque of the drive roller are each inclined between 6° and 20° with respect to the radial direction.

8. The drive roller according to claim 1, for a conveyor belt with engagement elements, wherein the length of the teeth in the radial direction is matched to the size of the engagement elements of the conveyor belt.

9. The drive roller according to claim 1, wherein the teeth project beyond a bottom of the engagement portions in the radial direction by 0.5 cm-1.5 cm.

10. The drive roller according to claim 1, wherein the profile shell is made of polyurethane.

11. The drive roller according to claim 1, wherein the drive roller has a drum motor for rotating the drive roller about a longitudinal axis thereof.

12. The drive roller according to claim 11, wherein the profile shell and the drum motor are one of frictionally and positively connected to one another.

13. A conveyor band comprising at least one drive roller, according to claim 1, and a conveyor belt, wherein the drive roller is formed as an idler pulley for the conveyor belt.

14. The conveyor band according to claim 13, wherein the conveyor belt is formed to be substantially as wide as the drive roller extends in the axial direction.

15. The conveyor band according to claim 13, wherein a clearance of the drive roller is formed to be greater than a clearance of the conveyor belt.
